(19) United States
(12) Patent Application Publication
(10) Pub. No.: US 2008/0070544 A1
(43) Pub. Date: Mar. 20, 2008

(54) Systems and methods for informing a mobile node of the authentication requirements of a visited network

(75) Inventor: Avi Lior, Ontario (CA)

Correspondence Address: STERNE, KESSLER, GOLDSTEIN & FOX P.L.L.C., 1100 NEW YORK AVENUE, N.W., WASHINGTON, DC, 20005, US

(73) Assignee: Bridgewater Systems Corp., Ottawa, Ontario (CA)

(21) Appl. No.: 11/522,935

(22) Filed: Sep. 19, 2006

(51) Int. Cl. H04M 11/04

(52) U.S. Cl. 455/404.1

(57) ABSTRACT

Systems and methods for a mobile node having a home network to determine an authentication policy of a visited network in a communications network using the Extensible Authentication Protocol (EAP) are provided. In an embodiment, the method includes a mobile node receiving an EAP Request Identity message from the visited network. The mobile node then determines the visited network's authentication policy based on the received EAP Request Identity message. Once the mobile node has determined the visited network's authentication policy, the mobile node selects an authentication policy based on the visited network's authentication policy and on its home network's authentication policy. The mobile node then transmits an EAP Response Identity message that includes the selected authentication policy. The mobile node includes, but is not limited to laptop computers, cellular phones, smart phones, and personal data assistants.

### BACKGROUND OF THE INVENTION

1. Field of the Invention

The present invention relates to mobile communications, and more particularly, to authentication of mobile nodes.

2. Background of Invention

An increasingly large number of individuals use portable computing devices, such as laptop computers, personal data assistants (PDAs), smart phones and the like, to support mobile communications. The number of computing devices, and the number of networks that these devices connect to, has increased dramatically in recent years. For example, traditional cellular telephone use and mobility continue to grow as the number of cellular subscribers in the United States exceeded 200M for the first time in 2005, with revenues from roaming services (e.g., services used by a cell phone user in a visited network other than their home network) reaching nearly 4B USD. Similarly, an increasing number of wireless Internet access services have been appearing in airports, cafes and book stores with revenue projected from wireless local area network (“LAN”) services to exceed 15B USD in 2007.

In a typical wireless Internet environment, Wi-Fi based hotspots could be adjacent or distributed in cellular telephone networks. When the services of wireless LAN and cellular networks are integrated, the mobile node (e.g., laptop computer) can move across networks. There are two types of roaming: roaming between the same type of network (e.g., wireless LAN to wireless LAN or cellular network to cellular network) is defined as horizontal roaming; roaming between different types of networks, such as a wireless LAN and a cellular network, is defined as vertical roaming.

The service provider allowing access to its network usually requires a mobile node and/or a mobile user to authenticate that it is entitled to access the network before it is granted network access. Authentication is the process of identifying a device or user. For example, when logging on to a computer network, user authentication is commonly achieved using a username and password. Authentication is distinct from authorization, which is the process of giving devices or individuals access to services and features based on their identity. Authentication merely ensures that an individual is who he or she claims to be, but does not address the access rights of the individual.

Accordingly, a wireless network generally includes many wireless nodes and users trying to gain access to a network. The primary means for controlling access include network access servers (“NAS”) and authentication servers. A NAS provides access to the network. A primary authentication server, such as an authentication, authorization, accounting (AAA) server, provides centralized authentication services to a NAS for authenticating client devices before they are granted access to the network. In typical installations, the devices and users are connecting through the NAS to obtain access to a network (e.g., the Internet) via some form of wireless connection. The authentication server is typically a RADIUS (Remote Authentication Dial-In User Service) or Diameter server.

In this type of network access server environment, the Extensible Authentication Protocol (EAP) is typically used for network authentication. For further information regarding EAP, see e.g., “RFC 3748: Extensible Authentication Protocol,” by the Internet Engineering Task Force (IETF), the disclosure of which is hereby incorporated by reference. EAP is a general protocol for authentication, which supports multiple authentication mechanisms. The client devices and the authentication server (e.g., RADIUS or DIAMTER server) exchange EAP messages by embedding them as attributes of a RADIUS packet. For further information regarding RADIUS, see, e.g., “RFC 2865: Remote Authentication Dial In User Service (RADIUS),” by the IETF, the disclosure of which is hereby incorporated by reference. See also, “RFC 4072: Diameter Extensible Authentication Protocol (EAP) Application, by the IETF, the disclosure of which is hereby incorporated by reference.

Authentication requirements vary widely among wireless network providers. Generally, when accessing a network, a mobile node is required to authenticate with that network. Several types of authentication schemes exist, including, but not limited to, device authentication and user authentication. Device authentication refers to the situation in which a terminal authenticates with a network. User authentication refers to the situation in which a user authenticates with a network. In other cases, some networks require no authentication and some have specific authentication requirements.

The home network's authentication requirements are typically pre-configured in a mobile node. However, the visiting network's (where the mobile node is roaming) authentication policy, for scaling reasons, can not be preconfigured and must be learned by the mobile node as it is roaming. In a large roaming environment that uses EAP, when a mobile node moves from one network access server coverage area to another, it needs to re-authenticate using EAP. At each new network access server there may be a different authentication policy requiring the mobile node to authenticate the device and/or the subscriber. The mobile node needs to know the policy and be authenticated correctly before network access is granted.

Currently the only method available for a mobile node to know the authentication policy at the visited network is for the mobile node to be pre-configured with the policy. The configuration can be done a priori to the mobile node arriving at the visited network, or the mobile node can be configured before network access is granted. This presents a major challenge in that pre-configuration does not scale well or provide certainty that a mobile node will have all configuration schemes for the many possible networks that may be visited. Furthermore, current approaches to provisioning authentication policies at the time of arrival to a visited network can be very expensive in that they require the execution complex procedures.

What are needed are cost effective systems and methods for systems and methods for informing a mobile node of the authentication requirements of a visited network.

### SUMMARY OF THE INVENTION

The present invention provides systems and methods for a mobile node having a home network to determine an authentication policy of a visited network in a communications network using the Extensible Authentication Protocol (EAP). In an embodiment, the method includes a mobile node receiving an EAP Request Identity message from the visited network. The mobile node then determines the visited network's authentication policy based on the received EAP Request Identity message. Once the mobile node has determine the visited network's authentication policy, the mobile node selects an authentication policy based on the visited network's authentication policy and on its home network's authentication policy. The mobile node then transmits an EAP Response Identity message that includes the selected authentication policy. The mobile node includes, but is not limited to laptop computers, cellular phones, smart phones, and personal data assistants.

In another embodiment a method includes a network access server receiving an EAP Start message. The network access server then transmits an EAP Request Identity message that includes an authentication policy for the visited network. The network access server receives an EAP Response Identity message that includes an authentication policy based on the policy transmitted in the second step and the authentication policy of the mobile node's home network. Finally, the network access server routes the EAP Response Identity message based on the contents of the EAP Response Identity message.

Further embodiments, features, and advantages of the invention, as well as the structure and operation of the various embodiments of the invention are described in detail below with reference to accompanying drawings.

### BRIEF DESCRIPTION OF THE FIGURES

The present invention is described with reference to the accompanying drawings. In the drawings, like reference numbers indicate identical or functionally similar elements. The drawing in which an element first appears is indicated by the left-most digit in the corresponding reference number.

FIG. 1 provides a diagram of a global architecture of the public wireless Internet.

FIG. 2 provides a network diagram of a portion of a roaming environment.

FIG. 3 provides a method for a mobile node to determine an authentication policy of a visited network in a communication network using EAP, according to an embodiment of the invention.

FIG. 4 provides a method for a mobile node to determine an authentication policy of a visited network in a communication network using EAP when the policy is based on the identity of the mobile node, according to an embodiment of the invention.

FIG. 5 is a diagram of a computer system on which the methods and systems herein described can be implemented, according to an embodiment of the invention.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

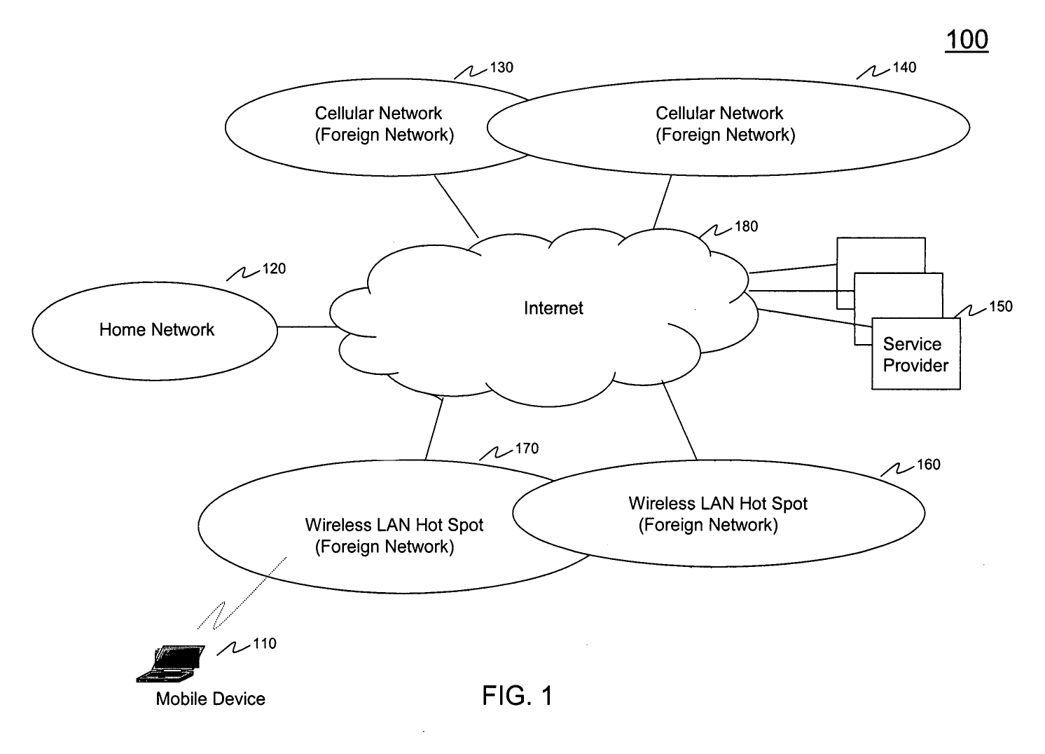

FIG. 1 provides architecture 100 of the public wireless Internet. Architecture 100 includes home network 120, cellular networks 120 and 140, service providers 150, wireless LAN hot spot 160 and 170 and Internet 180. Architecture 100 provides a very simplified diagram of wireless network to illustrate the concepts of a home network and a visited network to highlight the need for authentication procedures. As will be known by individuals skilled in the relevant arts, the present invention can be used on both public and private interconnected wireless networks that require authentication of a mobile device and/or user when that device or user accesses a foreign or visited network that differs from the device or user's home network.

Home network 120 can be any type of wireless network, such as a cellular network or a wireless LAN. Home network 120 represents the home network of mobile device 110. Mobile device 110 can include a laptop computer, a cellular phone, a smart phone, a PDA or other wireless mobile device. Mobile device 110 is shown as currently having a wireless connection to wireless LAN hot spot 170. As will be known by individuals skilled in the relevant arts, mobile device 110 can roam from one network to another, provided that the proper roaming arrangements are in place between network providers and that mobile device 110 can be properly authenticated when entering a visited or foreign network, such as wireless LAN hot spot 170 or cellular network 140. Each of the networks is coupled through Internet 180. Other types of public and private networks can be used to couple the networks.

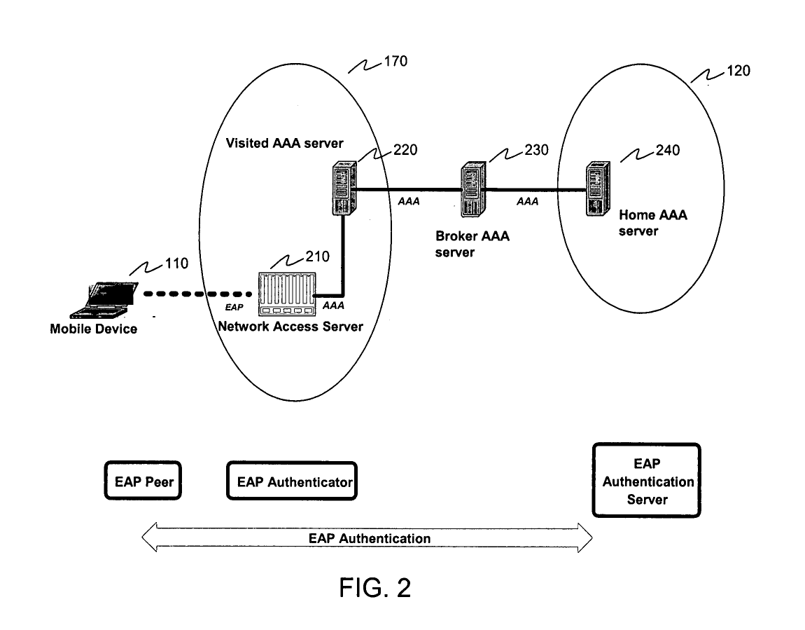

FIG. 2 provides a network diagram of a portion of a roaming environment within the context of architecture 100. The diagram provides a simplified network view that can be used to illustrate the authentication procedures needed when a mobile device roams from one network to another. In the example of FIG. 2, mobile device 110 seeks network access to wireless LAN hot spot 170. Network access server 210 and Visited Authentication, Authorization, Accounting (AAA) server 220 within wireless LAN hot spot 170 support access and authentication of mobile users. Visited AAA server 220 is coupled to broker AAA server 230. Broker AAA server 230 provides a means for network providers to more efficiently couple their networks by using brokers to support multiple relationships, rather than simply have multitudes of peer-to-peer connections among AAA servers. Broker AAA server 230 is coupled to home AAA server 240 within mobile device 110's home network 120. For the purposes of authentication, mobile device 110 is wirelessly coupled to network access server using EAP.

EAP provides an authentication framework that supports multiple authentication methods. EAP typically runs directly over data link layers, such as point-to-point protocol (“PPP”) or IEEE 802., without requiring IP. EAP may be used on dedicated lines, as well as switched circuits, and wired as well as wireless links. Deployments of IEEE 802.11 wireless LANs are based on EAP and use several EAP methods, including EAP-TLS (Transport Level Security), EAP-TTLS (Tunneled Transport Level Security), PEAP (Protected Extensible Authentication Protocol), and EAP-SIM (Subscriber Identify Module). These methods support authentication credentials that include digital certificates, user-names and passwords, secure tokens, and SIM secrets. The present invention can be implemented with each of these methods, but is not limited to these methods. Furthermore, the embodiments discussed herein focus on wireless links, however, the scope and spirit of the present invention extends to wired links, as well.

Using EAP nomenclature, mobile device 110 is considered an EAP peer, while network access server 210 is considered an EAP authenticator and home AAA server 240 is considered an EAP authentication server.

One of the advantages of the EAP architecture is its flexibility. EAP is used to select a specific authentication mechanism, typically after the authenticator requests more information in order to determine the specific authentication method to be used. Rather than requiring the authenticator to be updated to support each new authentication method, EAP permits the use of a backend authentication server, which may implement some or all authentication methods, with the authenticator acting as a pass-through for some or all methods and peers.

Referring to FIG. 2, when mobile device 110 attaches to the network access server 210, it needs to authenticate with home AAA server 240 before network access is granted. The authentication is based on EAP and mobile device 110, network access server 210 and home AAA server 240 take on EAP roles, as identified above. EAP messages are transported between the mobile device 110 acting as an EAP Peer to the network access server 210, the EAP Authenticator, using any of many transport methods, such as 802.1x, PANA, and the like. The transport between network access server 210 and home AAA server 240 is typically carried over AAA protocol using RADIUS or Diameter. The EAP messages travel through a visited AAA server 220, zero or more broker AAA server(s) 230 and finally arrive at the home AAA server 240.

Currently the only method available for mobile device 110 to know the policy at the visited network, wireless LAN hot spot 170 is for mobile device 110 to be configured with the policy. The configuration could be done a priori to the mobile node arriving at the visited network, or mobile device 110 can be configured before network access is granted. Provisioning of mobile device 110 at the time of arrival is very expensive requiring the execution of a complex procedure.

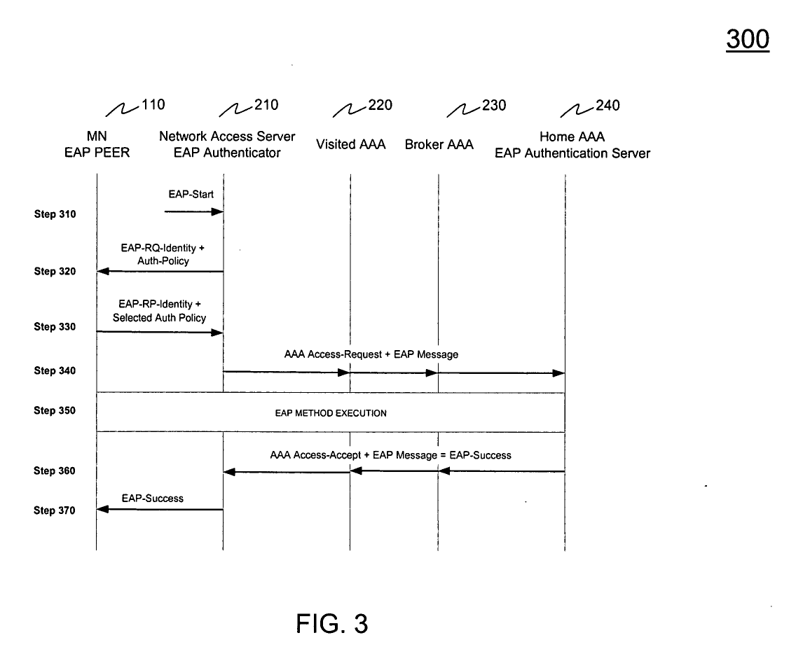

FIG. 3 provides a method 300 for a mobile node to determine an authentication policy of a visited network in a communication network using EAP, according to an embodiment of the invention. Method 300 begins in step 310.

In step 310, network access server 210 receives an EAP-Start message. This message comes from the network and signals that the EAP procedure should start.

In step 320 network access server 210, which is located in the visited network, issues an EAP-Request-Identity message. If network access server 210 knows the visited network Authentication Policy, it will encode the policy as part of the EAP-Request-Identity message, as shown in this FIG. 3. The coding of the message should be similar to the encoding used in RFC4284, and will be known to individuals skilled in the relevant arts based on the teachings herein and reference to RFC4284.

In step 330, the mobile device 110 receives the EAP-Request-Identity. Mobile device 110 decodes the message to learn the authentication policy of the visited network. Mobile device 110 uses that knowledge and the preconfigured knowledge of the authentication policy of its home network 120 to select the authentication policy required. Mobile device 110 encodes the authentication policy in an EAP-Response Identity message and sends the message to network access server 210.

In step 340, network access server 210 decodes the EAP-Response Identity message and may act on it or may forward the message to home network 120. The routing of the message is typically based on the contents of the EAP-Response-Identity. As shown in FIG. 3, the network access server 210, acting as the EAP Authenticator, does not act further on the EAP message other then encapsulating it in a AAA Access-Request message.

In step 350, Home AAA server 240 receives the Access-Request containing the EAP-Response-Identity and the selection for the authentication method, as it determined from the visited network policy conveyed in step 320 and the policy configured in mobile node 110. Home AAA server 240, acting as the EAP Authentication Server, then starts to execute an EAP method appropriate to the authentication method selected. The EAP method continues to execute until it succeeds or fails. Steps 360 and 370 illustrate a successful authentication occurring that enable mobile device 110 to access network 170. Specifically, in step 370 mobile device 110 receives an EAP-Success message. If successful authentication does not occur, ultimately the process will time out.

If the authentication method required two EAP methods to be executed, one for the device and one for the user, then upon completion of the first EAP method another may start to execute.

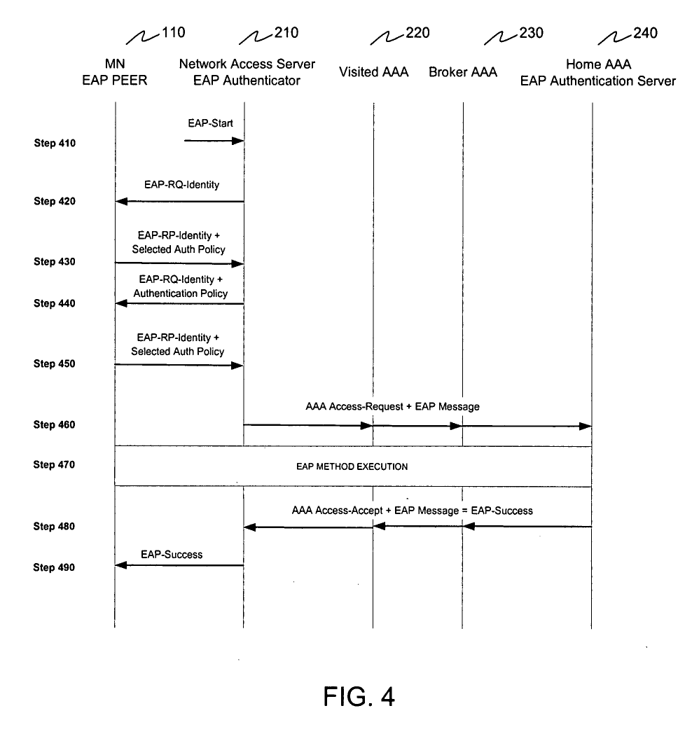

In an alternative scenario the visited network's authentication policy may be based on the identity of a mobile node. FIG. 4 provides a method 400 for a mobile node to determine an authentication policy of a visited network in a communication network using EAP when the policy is based on the identity of the mobile node, according to an embodiment of the invention. Method 400 begins in step 410.

In step 410, network access server 210 receives an EAP-Start message. This message comes from the network and signals that the EAP procedure should start.

In step 420, the network access server 210 is in a visited network whose authentication policy is dependant on the home network of the mobile node. Therefore, network access server sends an EAP-Request Identity message that does not contain an authentication policy selection.

In step 430, the mobile device 110 sends an EAP-Response Identity message that contains its selected authentication policy, which is based on configuration information within mobile device 110.

In step 440, since the Authentication Policy specified by mobile device 110 does not conform to its policy for the mobile device, network access server 210 responds back with an EAP-Request-Identity plus the authentication policy preferred by the visited network. If the authentication policy received by network access server 210 was consistent with the visited network's authentication policy, network access server 210 would proceed to step 460.

In step 450, mobile device 110 learns the authentication policy of the visited network and responds accordingly with an EAP-Response Identity message.

In step 460, network access server 210 decodes the EAP-Response Identity message and may act on it or may forward the message to home network 120. The routing of the message is typically based on the contents of the EAP-Response-Identity. As shown in FIG. 4, the network access server 210, acting as the EAP Authenticator, does not act further on the EAP message other then encapsulating it in a AAA Access-Request message.

In step 470, Home AAA server 240 receives the Access-Request containing the EAP-Response-Identity and the selection for the authentication method, as it determined from the visited network policy conveyed in step 440 and the policy configured in mobile node 110. Home AAA server 240, acting as the EAP Authentication Server, then starts to execute an EAP method appropriate to the authentication method selected. The EAP method continues to execute until it succeeds or fails. Steps 480 and 490 illustrate a successful authentication occurring that enable mobile device 110 to access network 170. Specifically, in step 480 mobile device 110 receives an EAP-Success message. If successful authentication does not occur, ultimately the process will time out.

Note that this scheme of communicating the visited network policy can also extend to the broker networks. That is, the Broker AAA networks, represented by broker AAA server 230, can also use EAP-Request Identity to convey an Authentication Policy to a mobile device, such as mobile device 110.

Methods 300 and 400 can be implemented in networks based on a variety of protocols, including but not limited to WIMAX and 3GPP2.

### Computer System Implementation

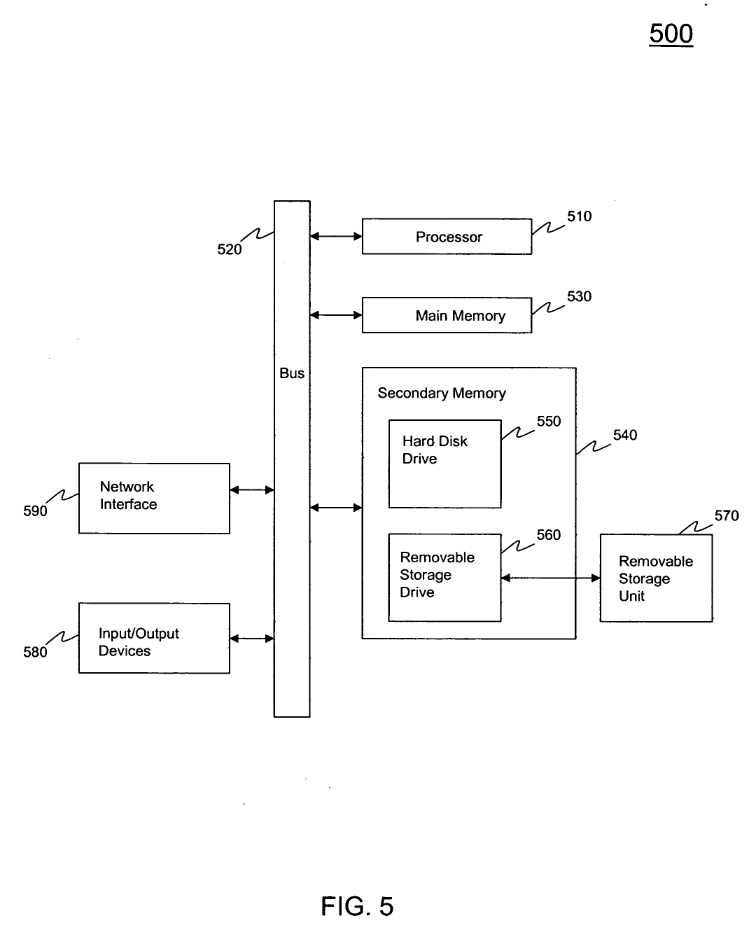

In an embodiment of the present invention, the methods and systems of the present invention described herein are implemented using well known computers, such as a computer 500 shown in FIG. 5. The computer 500 can be any commercially available and well known computer capable of performing the functions described herein, such as computers available from International Business Machines, Apple, Sun, HP, Dell, Cray, etc.

Computer 500 includes one or more processors (also called central processing units, or CPUs), such as processor 510. Processor 500 is connected to communication bus 520. Computer 500 also includes a main or primary memory 530, preferably random access memory (RAM). Primary memory 530 has stored therein control logic (computer software), and data.

Computer 500 may also include one or more secondary storage devices 540. Secondary storage devices 540 include, for example, hard disk drive 550 and/or removable storage device or drive 560. Removable storage drive 560 represents a floppy disk drive, a magnetic tape drive, a compact disk drive, an optical storage device, tape backup, ZIP drive, JAZZ drive, etc.

Removable storage drive 560 interacts with removable storage unit 570. As will be appreciated, removable storage unit 560 includes a computer usable or readable storage medium having stored therein computer software (control logic) and/or data. Removable storage drive 560 reads from and/or writes to the removable storage unit 570 in a well known manner.

Removable storage unit 570, also called a program storage device or a computer program product, represents a floppy disk, magnetic tape, compact disk, optical storage disk, ZIP disk, JAZZ disk/tape, or any other computer data storage device. Program storage devices or computer program products also include any device in which computer programs can be stored, such as hard drives, ROM or memory cards, etc.

In an embodiment, the present invention is directed to computer program products or program storage devices having software that enables computer 500, or multiple computer 500s to perform any combination of the functions described herein

Computer programs (also called computer control logic) are stored in main memory 530 and/or the secondary storage devices 540. Such computer programs, when executed, direct computer 500 to perform the functions of the present invention as discussed herein. In particular, the computer programs, when executed, enable processor 510 to perform the functions of the present invention. Accordingly, such computer programs represent controllers of the computer 500.

Computer 500 also includes input/output/display devices 3180, such as monitors, keyboards, pointing devices, etc.

Computer 500 further includes a communication or network interface 590. Network interface 590 enables computer 500 to communicate with remote devices. For example, network interface 590 allows computer 500 to communicate over communication networks, such as LANs, WANs, the Internet, etc. Network interface 590 may interface with remote sites or networks via wired or wireless connections. Computer 500 receives data and/or computer programs via network interface 590. The electrical/magnetic signals having contained therein data and/or computer programs received or transmitted by the computer 500 via interface 590 also represent computer program product(s).

The invention can work with software, hardware, and operating system implementations other than those described herein. Any software, hardware, and operating system implementations suitable for performing the functions described herein can be used.

### CONCLUSION

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

What is claimed is:

1. In a communications network using the Extensible Authentication Protocol (EAP), a method for a mobile node having a home network to determine an authentication policy of a visited network, comprising:
(a) receiving an EAP Request Identity message from the visited network;
(b) determining the visited network's authentication policy based on the received EAP Request Identity message;
(c) selecting an authentication policy based on the visited network's authentication policy and on its home network's authentication policy; and
(d) transmitting an EAP Response Identity message that includes the selected authentication policy.

2. The method of claim 1, further comprising:
(e) receiving an EAP Success message confirming a successful authentication policy.

3. The method of claim 1, wherein a mobile node comprises a cellular telephone, a smart phone, a laptop computer, or a personal data assistant.

4. The method of claim 1, wherein the communications network comprises a wireless network using a WIMAX or 3GPP2 protocol.

5. In a communications network using the Extensible Authentication Protocol (EAP), a method for a network access server to enable a mobile node having a home network to determine an authentication policy of a visited network, comprising:
(a) receiving an EAP Start message;
(b) transmitting an EAP Request Identity message that includes an authentication policy for the visited network;
(c) receiving an EAP Response Identity message that includes an authentication policy based on the policy transmitted in step (b) and the authentication policy of the mobile node's home network; and
(d) routing the EAP Response Identity message based on the contents of the EAP Response Identity message.

6. The method of claim 5, further comprising:
(e) transmitting an EAP Success message to the mobile node when EAP authentication is successful; and
(f) timing out when EAP authentication is unsuccessful.

7. The method of claim 5, wherein a mobile node comprises a cellular telephone, a smart phone, a laptop computer, or a personal data assistant.

8. The method of claim 5, wherein the communications network comprises a wireless network using a WIMAX or 3GPP2 protocol.

9. In a communications network using the Extensible Authentication Protocol (EAP), a method for a network access server to enable a mobile node having a home network to determine an authentication policy of a visited network when the policy is based on the identity of the mobile node, comprising:
(a) receiving an EAP Request Identity message from the visited network, wherein the EAP Request Identity message does not include an authentication policy selection;
(b) transmitting an EAP Response Identity message that contains a selected authentication policy based on configuration information within the mobile device;
(c) when the selected authentication policy differs from the authentication policy of the visited network, receiving an EAP Request Identity message that contains the visited network's authentication policy based on the identity of the mobile device;
(d) when the selected authentication policy is the same as the authentication policy of the visited network, receiving an EAP Success message; and
(e) determining the visited network's authentication policy based on the received EAP Request Identity message;
(f) selecting an authentication policy based on the visited network's authentication policy and on its home network's authentication policy; and
(g) transmitting an EAP Response Identity message that includes the selected authentication policy.

10. The method of claim 9, further comprising:
(e) receiving an EAP-Success message confirming a successful authentication policy.

11. The method of claim 9, wherein a mobile node comprises a cellular telephone, a smart phone, a laptop computer, or a personal data assistant.

12. The method of claim 9, wherein the communications network comprises a wireless network using a WIMAX or 3GPP2 protocol.
